(19) United States
(12) Patent Application Publication
(10) Pub. No.: US 2020/0212753 A1
(43) Pub. Date: Jul. 2, 2020

(54) MOTOR

(71) Applicant: NIDEC CORPORATION, Kyoto (JP)

(72) Inventors: Yoshihisa OKUHATA, Kanagawa (JP); Kunihiro KAJITA, Kanagawa (JP); Mika KONAGAYA, Kanagawa (JP); Yosuke ITO, Kanagawa (JP)

(21) Appl. No.: 16/631,442

(22) PCT Filed: Jul. 25, 2018
(86) PCT No.: PCT/JP2018/027805

§ 371 Date: Jan. 15, 2020

(30) Foreign Application Priority Data
Jul. 28, 2017 (JP) 2017-147113

(51) Int. Cl. H02K 5/10; H02K 7/116; H02K 11/215; H02K 11/33; H02K 24/00

(52) U.S. Cl. CPC H02K 5/10; H02K 7/116; H02K 24/00; H02K 11/33; H02K 11/215

(57) ABSTRACT

In one aspect of a motor of the present invention, a housing has a stator housing portion and an inverter housing portion, and is a single member. A cover covers an opening on one side in an axial direction of a circumferential wall of a stator housing portion. A rotation detection unit detects the rotation of a rotor and is attached to a motor shaft on the one side in the axial direction of a stator. A speed-reduction device has a speed-reduction mechanism coupled to an end on the one side in the axial direction of the motor shaft and a casing in which the speed-reduction mechanism is housed. The rotation detection unit is covered by the casing from the one side in the axial direction.

### CROSS-REFERENCE TO RELATED APPLICATIONS

This is the U.S. national stage of application No. PCT/JP2018/027805, filed on Jul. 25, 2018, and priority under 35 U.S.C. § 119(a) and 35 U.S.C. § 365(b) is claimed from Japanese Application No. 2017-147113, filed on Jul. 28, 2017.

### FIELD OF THE INVENTION

The present invention relates to a motor.

### BACKGROUND

A motor driving apparatus and a vehicle have been known. A motor drive unit, which is an example of the motor driving apparatus, includes a first housing portion, a second housing portion, a first cover portion, and a second cover portion. The first housing portion houses a motor and a winding switcher. The second housing portion houses an inverter. The first housing portion includes a motor housing portion and a winding switcher housing portion. A non-load side of the motor housing portion is open and is provided with a resolver housing portion in which a resolver is disposed. The first cover portion is attached to the resolver housing portion by a screw member.

For example, when a resolver is attached to a portion of a motor shaft connected to a speed reduction device differently from the above-described unit, the resolver is covered by a cover, and the speed-reduction device is provided outside the cover. In this case, there is room for improvement in terms of simplifying a structure of the motor and shortening an assembly process.

### SUMMARY

One aspect of the motor of the present invention includes: a rotor having a motor shaft arranged along a central axis that extends in one direction; a stator opposing the rotor with a gap in a radial direction; an inverter electrically connected to the stator; a stator housing portion having a tubular circumferential wall and housing the stator; an inverter housing portion housing the inverter; a housing having the stator housing portion and the inverter housing portion as portions of a single member; a cover covering an opening on one side in an axial direction of the circumferential wall; a rotation detection unit which detects a rotation of the rotor and is attached to the motor shaft on the one side in the axial direction of the stator; and a speed-reduction device which has a speed-reduction mechanism coupled to an end on the one side in the axial direction of the motor shaft and a casing in which the speed-reduction mechanism is housed. The rotation detection unit is covered by the casing from the one side in the axial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a part of a motor according to the present embodiment;

FIG. 2 is a cross-sectional view illustrating a part of the motor according to the present embodiment; and

FIG. 3 is a cross-sectional view illustrating a part of a motor according to a modification of the present embodiment.

### DETAILED DESCRIPTION

A Z-axis direction illustrated in each drawing is a vertical direction Z in which a positive side is an upper side and a negative side is a lower side. A Y-axis direction is a direction parallel to a central axis J extending in one direction illustrated in each drawing and is a direction orthogonal to the vertical direction Z. In the following description, the direction parallel to the central axis J, that is, the Y-axis direction will be simply referred to as an “axial direction Y”. In addition, a positive side in the axial direction Y will be referred to as “one side in the axial direction”, and a negative side in the axial direction Y will be referred to as the “other side in the axial direction”. The X-axis direction illustrated in each drawing is a direction orthogonal to both the axial direction Y and the vertical direction Z. In the following description, the X-axis direction will be referred to as a “width direction X”. In addition, a positive side in the width direction X will be referred to as “one side in the width direction”, and a negative side in the width direction X will be referred to as the “other side in the width direction”.

In addition, a radial direction about the central axis J will be simply referred to as the “radial direction”, and a circumferential direction about the central axis J will be simply referred to as a “circumferential direction”. Note that the vertical direction, the upper side, and the lower side are simply names for describing a relative positional relationship of each portion, and an actual arrangement relationship or the like may be an arrangement relationship other than the arrangement relationship indicated by these names.

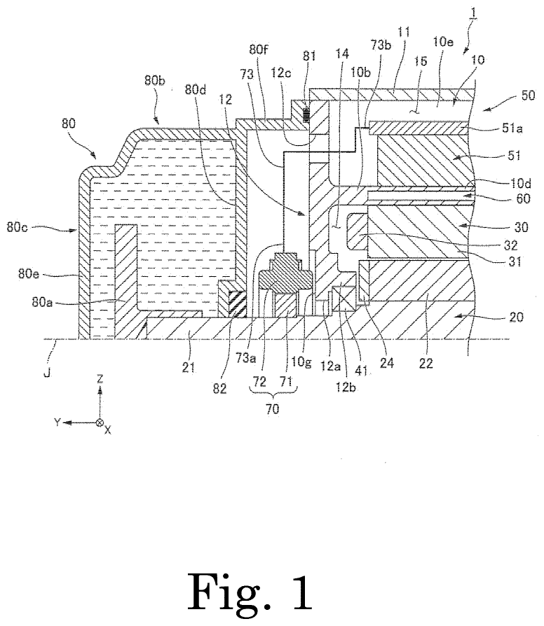

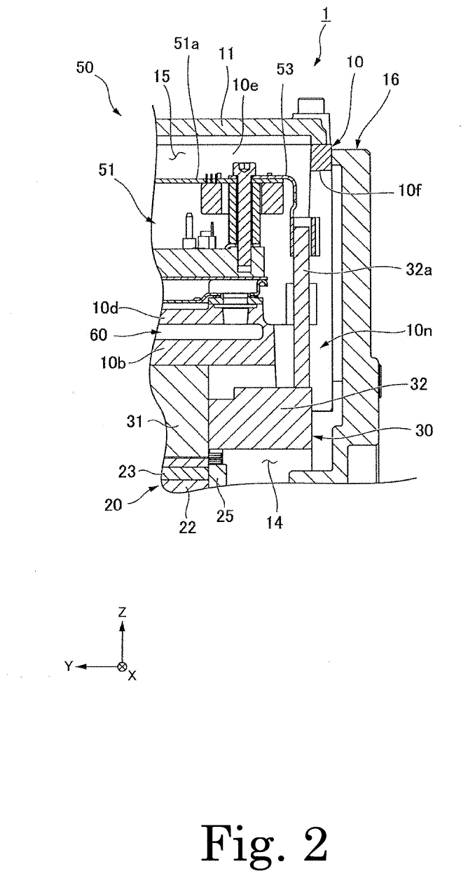

As illustrated in FIGS. 1 and 2, a motor 1 of the present embodiment includes a housing 10, a lid (upper lid) 11, a cover (front cover) 12, a rear cover member 16, a rotor 20 having a motor shaft 21 arranged along the central axis J, a stator 30, an inverter unit 50, a connector (not illustrated), a rotation detection unit 70, and a speed-reduction device 80.

The housing 10 houses the rotor 20, the stator 30, and the inverter unit 50. The housing 10 is a single member. The housing 10 is manufactured by sand casting, for example. The housing 10 includes a circumferential wall 10b and a rectangular tube portion 10e.

The circumferential wall 10b has a tubular shape surrounding the rotor 20 and the stator 30 on the radially outer side of the rotor 20 and the stator 30. In the present embodiment, the circumferential wall 10b has a substantially cylindrical shape centered on the central axis J. As illustrated in FIG. 2, the circumferential wall 10b is open at least on the other side in the axial direction. The circumferential wall 10b has a cooling unit 60 that cools the stator 30 and the inverter unit 50. The cooling unit 60 has a cooling flow path and a coolant flowing inside the cooling flow path. The stator housing portion 14 is constituted by the circumferential wall 10b. That is, the housing 10 has the tubular stator housing portion 14 having the circumferential wall 10b.

The rectangular tube portion 10e has a rectangular tube shape extending upward from the circumferential wall 10b. The rectangular tube portion 10e is open upward. The rectangular tube portion 10e has a through-hole 10f that penetrates a wall on the other side in the axial direction among the walls constituting the rectangular tube portion 10e in the axial direction Y. A lower end of the through-hole 10f is connected to an opening on the other side in the axial direction of the circumferential wall 10b. The rectangular tube portion 10e and the circumferential wall 10b constitute an inverter housing portion 15. That is, the housing 10 has the inverter housing portion 15.

The inverter housing portion 15 is located on the radially outer side of the stator housing portion 14. In the present embodiment, the inverter housing portion 15 is located above the stator housing portion 14 in the vertical direction Z orthogonal to the axial direction Y. The stator housing portion 14 and the inverter housing portion 15 are partitioned in the vertical direction Z by a partition wall 10d. The partition wall 10d is an upper portion of the circumferential wall 10b. That is, the circumferential wall 10b includes the partition wall 10d that partitions the stator housing portion 14 and the inverter housing portion 15. The partition wall 10d is located between the stator housing portion 14 and the inverter housing portion 15.

As illustrated in FIG. 2, at the end on the other side in the axial direction of the housing 10, the motor 1 has a housing opening 10n through which at least a part of the stator 30, the end on the other side in the axial direction of the partition wall 10d, and at least a part of the inverter housing portion 15 are exposed. A coil wire 32a extending from the stator 30 is arranged inside the housing opening 10n. That is, the coil wire 32a is arranged at the end on the other side in the axial direction of the housing 10. The coil wire 32a will be described later separately.

The lid 11 has a plate shape whose plate surface is orthogonal to the vertical direction Z. The lid 11 is fixed to an upper end of the rectangular tube portion 10e. The lid 11 closes an upper opening of the rectangular tube portion 10e.

As illustrated in FIG. 1, the cover 12 has a plate shape whose plate surface is orthogonal to the axial direction Y. The cover 12 is arranged at the end on the one side in the axial direction of the housing 10. The cover 12 blocks each one side in the axial direction of the circumferential wall 10b and the rectangular tube portion 10e. The cover 12 covers an opening on the one side in the axial direction of the circumferential wall 10b. The cover 12 covers an opening on the one side in the axial direction of the stator housing portion 14. The cover 12 covers an opening on the one side in the axial direction of the inverter housing portion 15. In the present embodiment, the housing 10 has the cover 12 as a portion of a single member.

The cover 12 has an output shaft hole 12a that penetrates the cover 12 in the axial direction Y. The output shaft hole 12a has, for example, a circular shape that passes through the central axis J. The cover 12 includes a tubular bearing holding portion 12b that protrudes from a circumferential edge of the output shaft hole 12a on a surface on the other side in the axial direction of the cover 12 to the other side in the axial direction. The bearing holding portion 12b holds a bearing 41 that supports the motor shaft 21 on the one side in the axial direction of the rotor core 22 to be described later.

The cover 12 has a sensor attachment portion 10g that is recessed from the one side in the axial direction to the other side in the axial direction of the cover 12. The sensor attachment portion 10g has a bottomed hole shape that is recessed from a surface, which faces the one side in the axial direction, of the cover 12 toward the other side in the axial direction. The sensor attachment portion 10g has a circular shape centered on the central axis J, for example, as viewed along the axial direction Y. The sensor attachment portion 10g has an inner circumferential surface and a bottom surface. The output shaft hole 12a is arranged at the center of the bottom surface. The bottom surface is an annular surface that faces the one side in the axial direction. In the present embodiment, the bottom surface is a plane perpendicular to the central axis J.

The cover 12 includes a through-hole (sensor wiring passage hole) 12c that penetrates the cover 12 in the axial direction Y. The through-hole 12c is open in the inverter housing portion 15.

As illustrated in FIG. 2, the rear cover member 16 has a plate shape whose plate surface is orthogonal to the axial direction Y. The rear cover member 16 is provided at the end on the other side in the axial direction of the housing 10. The rear cover member 16 is fixed to surfaces on the other side in the axial direction of the circumferential wall 10b and the rectangular tube portion 10e. The rear cover member 16 closes an opening on the other side in the axial direction of the circumferential wall 10b. The rear cover member 16 closes the through-hole 10f on the other side in the axial direction of the rectangular tube portion 10e. The rear cover member 16 covers the housing opening 10n located at the end on the other side in the axial direction of the housing 10 from the other side in the axial direction. The rear cover member 16 holds a bearing (not illustrated) that supports the motor shaft 21 on the other side in the axial direction of a rotor core 22 to be described later.

As illustrated in FIGS. 1 and 2, the rotor 20 includes the motor shaft 21, rotor core 22, a magnet 23 (see FIG. 2), a first end plate 24, and a second end plate 25. The motor shaft 21 is rotatably supported by the bearings on both sides in the axial direction. A portion of the motor shaft 21 on the one side in the axial direction is rotatably supported by the bearing 41.

As illustrated in FIG. 1, an end on the one side in the axial direction of the motor shaft 21 protrudes from the end on the one side in the axial direction of the circumferential wall 10b toward the one side in the axial direction. The end on the one side in the axial direction of the motor shaft 21 passes through the output shaft hole 12a and protrudes to the one side in the axial direction from the cover 12. A speed-reduction mechanism 80a, which will be described later, of the speed-reduction device 80 is coupled to the one end in the axial direction of the motor shaft 21.

The rotor core 22 is fixed to an outer circumferential surface of the motor shaft 21. The magnet 23 is inserted into a hole that penetrates the rotor core 22 provided in the rotor core 22 in the axial direction Y. The first end plate 24 and the second end plate 25 have an annular plate shape that expands in the radial direction. The first end plate 24 and the second end plate 25 sandwich the rotor core 22 in the axial direction Y in the state of being in contact with the rotor core 22. The first end plate 24 and the second end plate 25 press the magnet 23, which has been inserted into the hole of the rotor core 22, from both sides in the axial direction.

The stator 30 opposes the rotor 20 with a gap in the radial direction. The stator 30 is arranged on the radially outer side of the rotor 20. The stator 30 is housed in the stator housing portion 14. The stator 30 includes a stator core 31 and a plurality of coils 32 attached to the stator core 31. The stator core 31 has an annular shape centered on the central axis J. An outer circumferential surface of the stator core 31 is fixed to an inner circumferential surface of the circumferential wall 10b. The stator core 31 opposes the outer side in the radial direction of the rotor core 22 with a gap.

The inverter unit 50 controls power to be supplied to the stator 30. The inverter unit 50 includes an inverter 51 and a capacitor (not illustrated). That is, the motor 1 includes the inverter 51 and the capacitor. The inverter 51 is housed in the inverter housing portion 15. The inverter 51 is fixed to an upper surface of the partition wall 10d. The inverter 51 includes a circuit board 51a. The circuit board 51a has a plate shape whose plate surface is orthogonal to the vertical direction Z. As illustrated in FIG. 2, a coil wire 32a is connected to the first circuit board 51a via a connector terminal 53. The connector terminal 53 is provided at the end on the other side in the axial direction of the inverter 51. As a result, the inverter 51 is electrically connected to the stator 30.

The coil wire 32a extends upward from the coil 32 of the stator 30. The coil wire 32a extends upward from an end on the other side in the axial direction of the coil 32. The coil wire 32a passes through the end on the other side in the axial direction of the partition wall 10d and is connected to the inverter 51. That is, the coil wire 32a extends from the stator housing portion 14 to the inverter housing portion 15 through the other side in the axial direction of the partition wall 10d.

The coil wire 32a includes three three-phase wiring bundles in which a plurality of coil wires are bundled for each of a U phase, a V phase, and a W phase. That is, the coil wire 32a is the three-phase coil wire 32a. In addition, the coil wire 32a includes a neutral-point wiring bundle in which a plurality of neutral-point coil wires are bundled. The neutral-point wiring bundle is the wiring bundle configured to connect the three three-phase wiring bundles by star connection.

The capacitor is housed in the inverter housing portion 15. The capacitor is electrically connected to the inverter 51. The capacitor is fixed to the upper surface of the partition wall 10d.

The connector is provided on the wall of the rectangular tube portion 10e. An external power supply (not illustrated) is connected to the connector. Power is supplied to the inverter unit 50 from the external power supply connected to the connector.

In FIG. 1, the rotation detection unit 70 detects the rotation of the rotor 20. The rotation detection unit 70 is attached to the motor shaft 21 on the one side in the axial direction of the stator 30. The rotation detection unit 70 detects, for example, a rotation angle position of the motor shaft 21 in the circumferential direction with respect to the housing 10. In this case, the rotation detection unit 70 may be rephrased as a rotation angle position detection sensor or a rotation angle sensor. In the present embodiment, the rotation detection unit 70 is a resolver. The rotation detection unit 70 is, for example, a variable reluctance (VR) resolver.

The rotation detection unit 70 is arranged on the one side in the axial direction of the cover 12. In the present embodiment, the rotation detection unit 70 is arranged in the sensor attachment portion 10g. A central axis of the rotation detection unit 70 is arranged coaxially with the central axis J of the motor shaft 21. The rotation detection unit 70 includes a detected portion 71 and a sensor unit 72.

The detected portion 71 has an annular shape extending in the circumferential direction. The detected portion 71 is attached to the rotor 20. The detected portion 71 is attached to the motor shaft 21. The detected portion 71 is fitted and fixed to the motor shaft 21. The detected portion 71 is arranged in a portion on the one side in the axial direction of the motor shaft 21. The detected portion 71 is made of a magnetic material. In the present embodiment, the rotation detection unit 70 is the resolver, and the detected portion 71 is a resolver rotor. The detected portion 71 is a rotating portion that rotates together with the rotor 20. The detected portion 71 is rotatable in the circumferential direction with respect to the sensor unit 72.

The sensor unit 72 has an annular shape extending in the circumferential direction. The sensor unit 72 is arranged on the radially outer side of the detected portion 71. The sensor unit 72 surrounds the detected portion 71 from the radially outer side. In the present embodiment, the rotation detection unit 70 is the resolver, and the sensor unit 72 is a resolver stator. The sensor unit 72 has a plurality of coils along the circumferential direction. The sensor unit 72 is a non-rotating portion that is fixed to the cover 12 and does not rotate.

The rotation detection unit 70 is fixed to the cover 12 by a fixing member (not illustrated). That is, the sensor unit 72 is fixed to the sensor attachment portion 10g of the cover 12. The fixing member is, for example, a screw member, a pin member, and the like. In the present embodiment, the fixing member detachably fixes the rotation detection unit 70 to the cover 12. A surface, which faces the other side in the axial direction, of the sensor unit 72 is arranged to be in contact with or close to the bottom surface, which faces the one side in the axial direction, of the sensor attachment portion 10g. The sensor unit 72 is directly or indirectly supported by this bottom surface from the other side in the axial direction.

When the detected portion 71 rotates together with the motor shaft 21, an induced voltage corresponding to a circumferential position of the detected portion 71 is generated in the coil of the sensor unit 72. The sensor unit 72 detects the rotation of the detected portion 71 by detecting the induced voltage. As a result, the rotation detection unit 70 detects the rotation of the rotor 20 by detecting the rotation of the motor shaft 21. The rotation information of the rotor 20 detected by the rotation detection unit 70 is sent to the inverter 51 via a sensor wiring 73 to be described later.

The motor 1 includes the sensor wiring 73 that electrically connects the rotation detection unit 70 and the inverter 51. The sensor wiring 73 extends from the rotation detection unit 70. The sensor wiring 73 extends upward from the sensor unit 72 of the rotation detection unit 70. The sensor wiring 73 includes a first end 73a connected to the rotation detection unit 70 and a second end 73b connected to the inverter 51. The first end 73a is connected to the sensor unit 72. The second end 73b is connected to the circuit board 51a.

The sensor wiring 73 passes through the through-hole 12c. That is, the sensor wiring 73 extends upward from the rotation detection unit 70 on the one side in the axial direction of the cover 12, passes through the through-hole 12c from the one side in the axial direction to the other side in the axial direction, and enters the inverter housing portion 15. The sensor wiring 73 includes a plurality of types of wirings having different functions although not illustrated. The plurality of wirings included in the sensor wiring 73 are arranged to be adjacent to each other in the width direction X, for example.

The speed-reduction device 80 increases the torque to be output from the motor 1 by the rotation of the rotor 20 and transmits the torque to a differential device or the like (not illustrated). That is, the speed-reduction device 80 has a function of increasing the torque by reducing a rotational speed of the rotor 20 and transmitting the torque to the differential device or the like.

The speed-reduction device 80 includes a speed-reduction mechanism 80a and a casing 80b in which the speed-reduction mechanism 80a is housed. The speed-reduction mechanism 80a is connected to an end (output end) on the one side in the axial direction of the motor shaft 21. The speed-reduction mechanism 80a has a plurality of types of gears such as a drive gear and an intermediate gear. A gear ratio of each gear of the speed-reduction mechanism 80a, the number of gears, and the like are appropriately selected in accordance with a desired reduction gear ratio. The speed-reduction device 80 of the present embodiment is, for example, a parallel shaft gear type reduction gear in which shaft cores of the respective gears of the speed-reduction mechanism 80a are arranged in parallel to each other.

The casing 80b includes an outer case 80c and an inner case 80d. The outer case 80c has a tubular shape with a top that has a top wall (front wall) 80e and a circumferential wall 80f. The top wall 80e has a plate shape whose plate surface is orthogonal to the axial direction Y. The top wall 80e is arranged on the one side in the axial direction of the speed-reduction mechanism 80a. The top wall 80e covers the speed-reduction mechanism 80a from the one side in the axial direction. That is, the outer case 80c covers the speed-reduction mechanism 80a from the one side in the axial direction.

An end on the one side in the axial direction of the circumferential wall 80f is closed by the top wall 80e. An end on the other side in the axial direction of the circumferential wall 80f is in contact with the cover 12. The end on the other side in the axial direction of the circumferential wall 80f is in contact with a surface, which faces the one side in the axial direction, of the cover 12. An opening on the other side in the axial direction of the circumferential wall 80f is closed by the cover 12. The output shaft hole 12a and the through-hole 12c of the cover 12 are arranged on the radially inner side of the end on the other side in the axial direction of the circumferential wall 80f. A sealing body 81 that comes into contact with the cover 12 is provided at the end on the other side in the axial direction of the circumferential wall 80f. The sealing body 81 has an annular shape extending in the circumferential direction. The sealing body 81 is, for example, an O-ring. In the present embodiment, an outer diameter of the circumferential wall 80f increases from the one side in the axial direction to the other side in the axial direction.

The inner case 80d has a plate shape whose plate surface is orthogonal to the axial direction Y. The inner case 80d has an annular shape that protrudes from an inner circumferential surface of the circumferential wall 80f to the radially inner side and extends in the circumferential direction. The motor shaft 21 extends to penetrate a center portion of the inner case 80d in the axial direction Y. The center portion of the inner case 80d includes a portion where a radial position of the inner case 80d is the same as the central axis J.

The inner case 80d is arranged on the other side in the axial direction of the speed-reduction mechanism 80a. The inner case 80d covers the speed-reduction mechanism 80a from the other side in the axial direction. The inner case 80d is arranged on the one side in the axial direction of the rotation detection unit 70. A sealing member 82 that comes into contact with the motor shaft 21 is provided at the radially inner end of the inner case 80d. The sealing member 82 has an annular shape extending in the circumferential direction. An outer circumferential surface of the sealing member 82 is fixed in contact with an inner circumferential surface of the inner case 80d. A surface, which faces the one side in the axial direction, of the sealing member 82 is fixed in contact with a surface, which faces the other side in the axial direction, of the inner case 80d. The sealing member 82 is, for example, an oil seal.

The speed-reduction mechanism 80a is housed in a space, surrounded by the top wall 80e, the circumferential wall 80f, and the inner case 80d, in the casing 80b. This space is filled with oil or the like. In addition, the rotation detection unit 70 and the sensor wiring 73 are partially housed in a space surrounded by the circumferential wall 80f, the inner case 80d, and the cover 12.

The rotation detection unit 70 is covered by the casing 80b from the one side in the axial direction. In the present embodiment, the rotation detection unit 70 is covered by the inner case 80d from the one side in the axial direction. Therefore, it is unnecessary to provide a cover member configured to cover the rotation detection unit 70 as a separate member on the outer side of the rotation detection unit 70 (on the one side in the axial direction). That is, a part (the inner case 80d) of the casing 80b that houses the speed-reduction mechanism 80a in the speed-reduction device 80 can be used (shared) as the cover body of the rotation detection unit 70 so that the number of parts can be reduced. As a result, the structure of the motor 1 can be simplified, and the assembly process can be shortened.

The rotation detection unit 70 is also covered by the casing 80b from the radially outer side. In the present embodiment, the rotation detection unit 70 is covered by the circumferential wall 80f from the radially outer side. As a result, for example, dust floating outside the motor 1 is prevented from adhering to the rotation detection unit 70, and the function of the rotation detection unit 70 is favorably maintained. In addition, the sealing body 81 is provided at the contact portion between the circumferential wall 80f and the cover 12 in the present embodiment. For this reason, the adhesion of dust or the like to the rotation detection unit 70 can be further suppressed.

In addition, the cover 12 is covered by the casing 80b from the one side in the axial direction in the present embodiment. The cover 12 is covered by the inner case 80d from the one side in the axial direction. Therefore, it is possible to prevent oil, dust, and the like from entering the housing 10 through the output shaft hole 12a, the through-hole 12c, and the like of the cover 12, for example.

In addition, the motor 1 of the present embodiment includes the sealing member 82, which comes into contact with the motor shaft 21, at the radially inner end of the inner case 80d. For this reason, it is possible to suppress flowing out of the oil or the like inside the casing 80b to the other side in the axial direction through a portion between an outer circumferential surface of the motor shaft 21 and the inner circumferential surface of the inner case 80d. Therefore, it is possible to further prevent the oil or the like from entering the inside of the housing 10.

In addition, the rotation detection unit 70 may be supported by the inner case 80d from the one side in the axial direction. In this case, for example, the rotation detection unit 70 can be held from both the sides in the axial direction Y between the inner case 80d and the cover 12.

In addition, the sensor wiring 73 passes through the through-hole 12c that is open in the inverter housing portion 15 in the present embodiment. For this reason, the sensor wiring 73 is easily routed. That is, it is unnecessary to route the sensor wiring 73 in the stator housing portion 14 in this case, and thus, for example, there is no need to bring the sensor wiring 73 into contact with the coil 32 of the stator 30 or to make the path for routing the sensor wiring 73 complicated. In the present embodiment, a member that hinders the routing of the sensor wiring 73 is not arranged on the one side in the axial direction of the cover 12 and on the other side in the axial direction of the inner case 80d. Therefore, the sensor wiring 73 can be easily routed with a simple path. As a result, the sensor wiring 73 can be optimally routed. In addition, the length of the sensor wiring 73 can be shortened.

In addition, a portion of the sensor wiring 73 between the rotation detection unit 70 and the through-hole 12c is covered by the casing 80b from the one side in the axial direction. In the present embodiment, the portion of the sensor wiring 73 located between the rotation detection unit 70 and the through-hole 12c is covered by the inner case 80d from the one side in the axial direction. In addition, the portion of the sensor wiring 73 between the rotation detection unit 70 and the through-hole 12c is covered by the casing 80b from the radially outer side. In the present embodiment, the portion of the sensor wiring 73 located between the rotation detection unit 70 and the through-hole 12c is covered by the circumferential wall 80f from the radially outer side. For this reason, the sensor wiring 73 can be protected. Accordingly, for example, it is unnecessary to provide a wiring cover configured to protect the sensor wiring 73 as a separate member. As a result, the number of parts can be reduced, and the structure of the motor 1 can be simplified.

Since the sensor wiring 73 is easily routed and the structure of the motor 1 is simplified as described above, the ease of assembly of the motor 1 is improved. The motor 1 of the present embodiment is suitable as a so-called electromechanical motor.

In addition, the periphery of the through-hole 12c of the cover 12 is closed, which is different from a groove, for example. Therefore, as the sensor wiring 73 passes through the through-hole 12c, a range of movement caused by shaking (racking) or the like of the sensor wiring 73 is suppressed. As a result, the sensor wiring 73 can be prevented from being damaged.

As illustrated in FIG. 2, the three-phase coil wire 32a extending from the stator 30 is arranged inside the housing opening 10n of the housing 10 in the present embodiment. The three-phase coil wire 32a is connected to the inverter 51 through the end on the other side in the axial direction of the partition wall 10d. That is, the sensor wiring 73 passes through the through-hole 12c of the cover 12 located at the end on the one side in the axial direction of the housing 10, and the three-phase coil wire 32a passes through the inside of the housing opening 10n located at the end on the other side in the axial direction of the housing 10.

In this case, the three-phase coil wire 32a led out from the stator 30 can be directly connected to the inverter 51. That is, a bus bar configured to connect the stator 30 and the inverter 51 is unnecessary, and the number of parts can be reduced.

In addition, when the stator 30 using no bus bar is attached to the stator housing portion 14, it is necessary to insert the stator 30 from the opening of the circumferential wall 10b toward the cover 12. That is, the stator 30 is inserted inside the circumferential wall 10b from the other side in the axial direction to the one side in the axial direction. In addition, the three-phase coil wire 32a is a highly rigid wire in the stator 30 using no bus bar, and it is difficult to easily bend the three-phase coil wire 32a like the sensor wiring 73. Therefore, making the three-phase coil wire 32a pass through, for example, a partition wall through-hole (not illustrated) or the like located at the end on the one side in the axial direction of the partition wall 10d of the circumferential wall 10b becomes difficult work.

Therefore, it is preferable to arrange the three-phase coil wire 32a on the opposite side of the sensor wiring 73 in the axial direction Y as in the present embodiment. Since the three-phase coil wire 32a is arranged inside the housing opening 10n where workability is favorable due to the wide opening, not only the sensor wiring 73 described above but also the three-phase coil wire 32a can be easily routed, and the ease of assembly is improved.

In addition, the housing opening 10n of the housing 10 is covered by the rear cover member 16 in the present embodiment. In this case, the housing opening 10n is closed by the single rear cover member 16, and thus, the structure of the housing 10 is simplified, and the assembly workability is also excellent.

Note that the present invention is not limited to the above-described embodiment, and various modifications can be made within a scope not departing from a spirit of the present invention, for example, as described below.

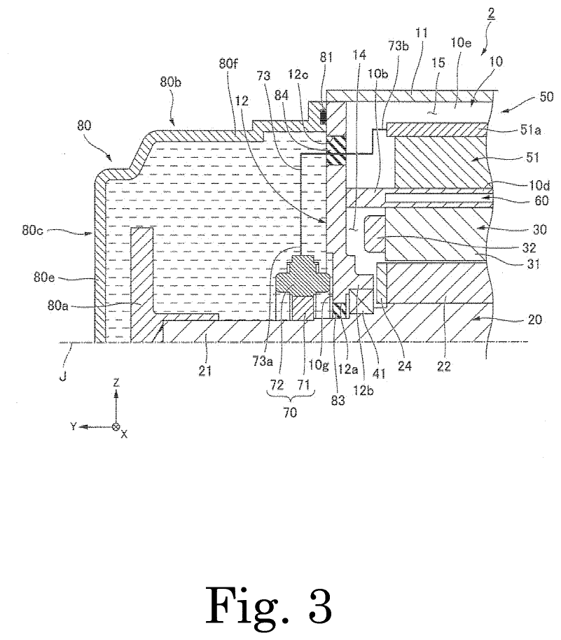

As in a motor 2 according to the present modification illustrated in FIG. 3, the casing 80b does not necessarily include the inner case 80d. In the present modification, the cover 12 is a portion, which covers the speed-reduction mechanism 80a from the other side in the axial direction, in the casing 80b. That is, the cover 12 constitutes a part of the casing 80b. In addition, the rotation detection unit 70 is covered by the outer case 80c from the one side in the axial direction. The rotation detection unit 70 is covered by the top wall 80e from the one side in the axial direction. In this case, the cover 12 can also serve as a case of the speed-reduction mechanism 80a, and thus, a structure of the motor 2 can be further simplified.

The motor 2 according to the present modification includes a first housing seal portion 83 coming into contact with the motor shaft 21 in the output shaft hole 12a of the cover 12. An outer circumferential surface of the first housing seal portion 83 is fixed in contact with an inner circumferential surface of the output shaft hole 12a. An inner circumferential surface of the first housing seal portion 83 is in contact with the outer circumferential surface of the motor shaft 21. In this case, oil or the like inside the casing 80b can be prevented from entering the housing 10 through the output shaft hole 12a. The first housing seal portion 83 is, for example, an oil seal.

The motor 2 according to the present modification includes a second housing seal portion 84 that blocks the through-hole 12c of the cover 12. The sensor wiring 73 extends to penetrate through the second housing seal portion 84 in the axial direction Y. The second housing seal portion 84 and the sensor wiring 73 come into contact with each other in the entire circumferential direction centered on the sensor wiring 73 without any gap. In this case, oil or the like inside the casing 80b can be prevented from entering the housing 10 through the through-hole 12c. In addition, the sealing body 81 prevents the oil or the like inside the casing 80b from leaking outside through a space between the circumferential wall 80f and the cover 12 in FIG. 3.

In the present modification, the cover 12 is a separate member from the housing 10. That is, the housing 10 is a portion as a single member and does not include the cover 12. The cover 12 is fixed to surfaces on the one side in the axial direction of the circumferential wall 10b and the rectangular tube portion 10e. The cover 12 closes an opening on the one side in the axial direction of the circumferential wall 10b. The cover 12 closes an opening on the one side in the axial direction of the rectangular tube portion 10e. In this case, the stator 30 may be inserted from the opening on the one side in the axial direction of the circumferential wall 10b to the other side in the axial direction, for example, when the motor 2 is assembled.

In addition, the rotation detection unit 70 is the resolver in the above-described embodiment, but the invention is not limited thereto. The rotation detection unit 70 may be a magnetic sensor such as an MR sensor having a magnetic resistance (MR) element, for example. In this case, the detected portion 71 is an MR sensor magnet. In addition, the sensor unit 72 is an MR sensor mounting board.

In addition, each configuration (constituent element) described in the above-described embodiment, modifications, and the writings may be combined within the scope not departing from the spirit of the present invention, and addition, omission, replacement, and other changes of the configuration are possible. In addition, the present invention is not limited by the above-described embodiment, and is limited only by the scope of the claims.

The present application claims the priority of Japanese Patent Application No. 2017-147113 filed on Jul. 28, 2017, the entire contents of which are hereby incorporated by reference.

What is claimed is:

1-8. (canceled)

9. A motor comprising:
a rotor having a motor shaft arranged along a central axis that extends in one direction;
a stator opposing the rotor with a gap in a radial direction;
an inverter electrically connected to the stator;
a stator housing portion having a tubular circumferential wall and housing the stator;
an inverter housing portion housing the inverter;
a housing having the stator housing portion and the inverter housing portion as portions of a single member;
a cover covering an opening on one side in an axial direction of the circumferential wall;
a rotation detection unit which detects a rotation of the rotor and is attached to the motor shaft on the one side in the axial direction of the stator; and
a speed-reduction device which has a speed-reduction mechanism coupled to an end on the one side in the axial direction of the motor shaft and a casing in which the speed-reduction mechanism is housed,
wherein the rotation detection unit is covered by the casing from the one side in the axial direction.

10. The motor according to claim 9, wherein
the casing includes an inner case that covers the speed-reduction mechanism from another side in the axial direction, and
the rotation detection unit is covered by the inner case from the one side in the axial direction.

11. The motor according to claim 10, further comprising
a sealing member provided in a radially inner end of the inner case and coming into contact with the motor shaft.

12. The motor according to claim 10, wherein
the rotation detection unit is supported by the inner case from the one side in the axial direction.

13. The motor according to claim 11, wherein
the rotation detection unit is supported by the inner case from the one side in the axial direction.

14. The motor according to claim 9, wherein
the casing includes an outer case that covers the speed-reduction mechanism from the one side in the axial direction,
the cover is a portion of the casing that covers the speed-reduction mechanism from the other side in the axial direction, and
the rotation detection unit is covered by the outer case from the one side in the axial direction.

15. The motor according to claim 9, further comprising:
a sensor wiring electrically connecting the rotation detection unit and the inverter; and
a through-hole penetrating the cover in the axial direction,
wherein the inverter housing portion is located on a radially outer side of the stator housing portion,
the cover covers an opening on the one side in the axial direction of the inverter housing portion,
the through-hole is open in the inverter housing portion,
the rotation detection unit is arranged on the one side in the axial direction of the cover, and
the sensor wiring passes through the through-hole.

16. The motor according to claim 10, further comprising:
a sensor wiring electrically connecting the rotation detection unit and the inverter; and
a through-hole penetrating the cover in the axial direction,
wherein the inverter housing portion is located on a radially outer side of the stator housing portion,
the cover covers an opening on the one side in the axial direction of the inverter housing portion,
the through-hole is open in the inverter housing portion,
the rotation detection unit is arranged on the one side in the axial direction of the cover, and
the sensor wiring passes through the through-hole.

17. The motor according to claim 11, further comprising:
a sensor wiring electrically connecting the rotation detection unit and the inverter; and
a through-hole penetrating the cover in the axial direction,
wherein the inverter housing portion is located on a radially outer side of the stator housing portion,
the cover covers an opening on the one side in the axial direction of the inverter housing portion,
the through-hole is open in the inverter housing portion,
the rotation detection unit is arranged on the one side in the axial direction of the cover, and
the sensor wiring passes through the through-hole.

18. The motor according to claim 12, further comprising:
a sensor wiring electrically connecting the rotation detection unit and the inverter; and
a through-hole penetrating the cover in the axial direction,
wherein the inverter housing portion is located on a radially outer side of the stator housing portion,
the cover covers an opening on the one side in the axial direction of the inverter housing portion,
the through-hole is open in the inverter housing portion,
the rotation detection unit is arranged on the one side in the axial direction of the cover, and
the sensor wiring passes through the through-hole.

19. The motor according to claim 13, further comprising:
a sensor wiring electrically connecting the rotation detection unit and the inverter; and
a through-hole penetrating the cover in the axial direction,
wherein the inverter housing portion is located on a radially outer side of the stator housing portion,
the cover covers an opening on the one side in the axial direction of the inverter housing portion,
the through-hole is open in the inverter housing portion,
the rotation detection unit is arranged on the one side in the axial direction of the cover, and
the sensor wiring passes through the through-hole.

20. The motor according to claim 14, further comprising:
a sensor wiring electrically connecting the rotation detection unit and the inverter; and
a through-hole penetrating the cover in the axial direction,
wherein the inverter housing portion is located on a radially outer side of the stator housing portion,
the cover covers an opening on the one side in the axial direction of the inverter housing portion,
the through-hole is open in the inverter housing portion,
the rotation detection unit is arranged on the one side in the axial direction of the cover, and
the sensor wiring passes through the through-hole.

21. The motor according to claim 9, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

22. The motor according to claim 10, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

23. The motor according to claim 11, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

24. The motor according to claim 12, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

25. The motor according to claim 13, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

26. The motor according to claim 14, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

27. The motor according to claim 15, wherein
the inverter housing portion is located on the radially outer side of the stator housing portion,
the circumferential wall has a partition wall located between the stator housing portion and the inverter housing portion,
a housing opening through which at least a part of the stator, an end on the other side in the axial direction of the partition wall, and at least a part of the inverter housing portion are exposed is provided at an end on the other side in the axial direction of the housing,
a three-phase coil wire extending from the stator is arranged inside the housing opening, and
the three-phase coil wire is connected to the inverter through the end on the other side in the axial direction of the partition wall.

28. The motor according to claim 9, wherein
the rotation detection unit is fixed to the cover by a fixing member.
